(19) United States
(12) Patent Application Publication
(10) Pub. No.: US 2006/0053105 A1
(43) Pub. Date: Mar. 9, 2006

(54) Method for information retrieval

(76) Inventor: Bernardo Nicolas Sanchez, Toronto (CA)

Correspondence Address: MARKS & CLERK, 1075 NORTH SERVICE ROAD WEST, SUITE 203, OAKVILLE, ON, L6M 2G2, CA

(21) Appl. No.: 10/532,191

(22) PCT Filed: Oct. 20, 2003
(86) PCT No.: PCT/CA03/01608

§ 371 Date: Apr. 21, 2005

(30) Foreign Application Priority Data
Oct. 22, 2002 (CA) 2,409,114

(51) Int. Cl. G06F 17/30

(52) U.S. Cl. 707/4

(57) ABSTRACT

A computerized information retrieval system is provided wherein a user can highlight relevant information, and otherwise identify and mark documents of interest (with or without annotations) for storage in a separate data structure. The stored documents can be documents located on the Internet, for example, but can also include documents located within the user's computer, or any other suitable storage device. Searches can then be conducted on the documents collected within the data structure preferably utilizing a permission-based access system. As such, a user can establish a data structure of relevant documents which can be searched by the user or other authorized users. A more efficient search can then be conducted by the authorized users.

### FIELD OF THE INVENTION

The present invention relates to the field of information retrieval systems, and in particular, relates to computerized information retrieval systems for saving and subsequent searching of a collection of selected, electronically stored documents.

### BACKGROUND OF THE INVENTION

The amount of information available to Internet users, and more generally to any computer user, has escalated rapidly and this trend shows little sign of decreasing in the near future. As such, it is becoming more and more difficult to locate and review information of relevance to a user. This is in spite of the availability of Internet Search engines such as Google, Yahoo, HotBot and the like. While these products have some utility in respect of a search of information on the Internet, they frequently retrieve a large number of irrelevant documents which the user must ignore while modifying or refining the search to better identify relevant documents. In a business situation, or the like, a large amount of time can be wasted as various members of a group basically repeat the same search procedures while searching for the same information. This might be alleviated by having a selected individual, such as a librarian conduct searches and circulate their findings, however, this type of report would be limited in utility for later searching and use.

A further difficulty in the use of this type of search engine is that the search is. limited to the Internet, and does not address documents stored on the user's computer system, for example, or an attached non-Internet based network system, such as a local Intranet or the like. Additionally, the search field includes a large variety of documents which may be totally irrelevant.

It is also known to provide software which has the ability to highlight various words or text passages within the document. Searches within a document can then be conducted on the highlighted text. However, this type of search is limited to the particular document being reviewed.

Further, modifications to documents can be provided using other means. for example, Woolf et al. in PCT/US00/33129, published Jun. 14, 2001, describes a system for providing highlighting or annotations to a copyrighted document, or other document which cannot be edited. The annotations can then be stored separately from original document but can be displayed when desired. However, no search function is described.

Sellen et al. in U.S. Patent Publication No. 2002/0062326, published May 23, 2002, and Huang, in U.S. Pat. No. 6,384,815, published May 7, 2002, also describe a methods for annotating or editing documents, but again, no search function is provided.

Schilit et al. in U.S. Pat. No. 6,279,014, published Aug. 21, 2001, provides a method for annotating documents. No method for searching on document content is provided. “ComMentor” as described by Roscheisen et al. in “Shared Web Annotations as a Platform for Third-Party Value-Added Information Providers: Architecture, Protocols, and Usage Examples”, Technical Report CSDTR/DLTR, Computer Science Department, Stanford University, Stanford, Calif. 94305, USA, provides a method for providing annotations to third party documents, and grouping or sorting by those annotations. However, searching of the document content is not provided.

Kamper in U.S. Pat. No. 5,982,370, published Nov. 9, 1999 provides a highlighting tool for selecting text within a document, and then interconnecting the highlighted text to a search engine so that a search of the Internet can be conducted on the highlighted material. However, it is noted that the search is to be conducted using an Internet search engine, on the information available over the Internet. As such, Kamper merely provides a tool for input of the search conditions.

To overcome the above stated difficulties, and to provide a more useful information search and retrieval function, it would therefore be advantageous to provide the ability to highlight, or otherwise select text within a variety of documents, and/or to select a variety of documents, and then be able to search through only the searchable content of the selected documents.

### SUMMARY OF THE INVENTION

Accordingly, it is a principal advantage of the present invention to provide a method for designating documents for inclusion in a user defined data structure.

It is a further advantage of the present invention to provide an information searching method to allow for searching of the information contained within the user defined data structure.

The advantages set out hereinabove, as well as other objects and goals inherent thereto, are at least partially or fully provided by the information search and retrieval system and method of the present invention, as set out herein below.

Accordingly, in one aspect, the present invention provides a computerized method of information retrieval comprising:
providing a computer displayable document having searchable content;
marking said document, with a marking device, as being a relevant document;
storing said relevant document in a user defined data structure; and
conducting a search of a number of said relevant documents using a search engine to identify documents with a desired searchable content;
selecting, using a selection device, the documents identified as having said desired searchable content, and displaying said selected document.

The present invention also provides a computerized system for operation of the method as described hereinabove with respect to the present invention. Accordingly, in a further aspect, the present invention also provides a computerized information retrieval system comprising:
a computer having a display for displaying documents having searchable content;
a marking device for marking document as being a relevant document;
a storage device for storing said relevant document in a user defined database; and
a search engine operatively connected to said computer for conducting a search of a number of said relevant documents in order to identify documents with a desired searchable content;
a selection device for selecting and displaying the documents identified as having said desired searchable content.

### DETAILED DESCRIPTION OF THE INVENTION

In the present application, the term “computer” or “computerized” primarily refers to a standard, stand-alone, traditional computer (including laptop computers and the like). However, the skilled artisan will be aware that the present invention can be used in a wide variety of devices, and used in a wide variety of application. These can include devices such as PDA's (personal digital assistants), Internet enabled cellular phones, Interactive Voice Response (IVR) systems, or the like. Accordingly, the term “computer” or modifications thereof, should be used as describing any electronic system over which a search or retrieval system might be usable.

Typically, the computer will include a display system in the form of a monitor or a flat screen display. However, the term “display” might also include methods of “audible” communication as well as visual. The computer will also include a marking device such as a mouse, a keyboard, a interactive screen display, an IVR response system, a joystick, a game pad, or the like. In general any device suitable for use in designating or selection a displayed option, or interacting with the computer, would be acceptable.

The documents displayed can be documents generated by standard computer software programs such as word processors, database programs, spreadsheet programs, e-mail and the like. Preferably, however, the documents are Internet Web pages which have been displayed on the user's computer display using, for example, a browser program running on the user's computer. Depending on the nature of the program used to generate the document, the text of the document can be stored in a variety of different manners. For example, a word processing file can be stored by storing a copy of the file, together with the file location and file name. A document located on the Internet can be stored by filing a copy of the Internet “html” file, together with the URL (Universal Resource Locator) of the document. Other file types can be stored in different fashions.

The documents are stored so that the searchable content is maintained. Preferably the documents are also stored in such a fashion that the original image of the document can be restored and displayed on the user's computer.

Accordingly, while the text of the document alone might be the only item stored, it is preferred that the file location, URL and the like also be stored in order that the original document could be recalled, and/or updated copies of the documents or Internet web pages can be retrieved for viewing. Preferably, the user is provided with the option of viewing either the original document, or the updated document.

Also, preferably the system is optionally provided with a method for determining the “best fit” of highlights from a previous version of a document, and displaying them at an appropriate location on the updated document.

As an additional feature, the retrieved page can also include additional and/or replacement text or images. For example, additional advertising images might be added to the screen view of a particular document. The content of the advertising can be customized based on the user's profile, or based on the search terms used. For example, a search conducted related to “automobiles” might generate additional or replacement advertising based on the demographic tendencies of consumers which match the user's profile.

The searchable content of the documents stored can be located in a variety of locations. The search can be conducted on strictly on the text of the document, on the highlighted text identified when the document was reviewed, or on added notes, attachments, paraphrases and the like. As such, the search could include the content of any the text, highlighted text, notes, annotations, summaries, attachments or paraphrasing of the document, which notes, annotations, summaries, attachments and paraphrasing are associated with the document, or on any suitable combination of these features. Accordingly, the search could be conducted on any or all of these features, and various users might be provided with differing levels of authority for conducting the search.

The search of the documents can be conducted using any suitable search “engine”, which can be related to the data structure, as discussed hereinbelow. The relevant content used for the search can be provided from the searchable content of the document, which as previously described can include the entire text, and/or the selected and/or highlighted text, notes, annotations and the like.

Marking of the selected documents can be accomplished by, for example, providing visible highlighting of the selected text. The user can be provided with a “tool bar’ which is visible on their computer screen with which they can highlight text, attach notes, summaries, other attachments or the like. Marking of the text can also merely be a tag to include a document in the data structure, without highlighting any particular section of text.

Further, the user can be provided with different types of audio or visual representations of highlighting, or of highlighting categories. This could be accomplished by, for example, playing different sounds for different highlight categories, or by distinguishing the different highlight categories by highlighting text with different fonts, colours or the like. As one example, access could be restricted to only those documents wherein the user has access to a particular colour. For example, to continue the automotive application, documents related to engine systems might be highlighted in a different colour than those related to braking systems. As such, someone interested in engines would only search only those documents which have been highlighted with a certain colour.

Further, the user might be able to establish personal data structures which are not visible by others, while also providing documents highlighted in a different colour to which other users can have access.

The data structure can be defined by the user, or a user control authority, so that a user is provided with access to only a relevant, or authorized databases and/or search results. The user is then authorized to conduct searches of relevant documents in only authorized data structures. As an example, an Application Service Provider might conduct searches for a variety of clients and provide a database of documents located. Users would be able to access authorized areas of the database and conduct searches on only those areas.

The data structure is preferably a database structure which allows for searching of the relevant content. The search engine can be included as a function or part of the database structure or can be a separate program. The data structure can be located on the user's computer, on a local storage device, a remote storage device, a network storage device, an Internet storage device, or an Application Service Provider storage device, or the like. The location of the database can be determined based on the amount of data to be stored, and the requirements for accessibility by other parties, if desired.

Once a search has been conducted, the user is preferably provided with a listing of relevant search result documents. The user can then select the desired documents using a selection device, which device can be any of the devices previously listed as marking devices. Once selected, the user is preferably provided with the option, if available, or viewing the original document, or an updated document, if an updated document exists. The user can then also be preferably provided with the option of viewing the various notes, attachments, annotations and the like, or simply view the selected document with or without any highlighting being visible.

The system of the present invention can also be modified to include various other features. For example, users could provide a standing search scheme and the system would provide an e-mail or other type of alert when new relevant content is added.

A further additional feature would include bookmarks within search results or search documents so that a user could store and save search lists and documents, and be able to resume searches at a later time.

Further, information on the documents highlighted or viewed might be tracked to determine documents of particular relevance or the like.

In a further aspect, the present invention also provides a computerized system having the computerized equipment required to store, search, access and display the documents to be highlighted, or the relevant documents which have been located as part of the search.

### BRIEF DESCRIPTION OF THE DRAWINGS

Embodiments of this invention will now be described by way of example only in association with the accompanying drawings. The drawings attached however, merely represent simple flow charts of the decision process which could be utilized in one embodiment of the present invention. It would be expected that those skilled in the art would be able to provide the necessary programming skills necessary for the operation of the system. The drawing attached include:

FIG. 1 which is a flow chart of a method for capturing data in a document for inclusion in the data structure;

FIG. 2 which is a method for adding notes to the document selected;

FIG. 3 which is a method for adding a paraphrase to a selected document;

FIG. 4 which is a method for displaying a selected document;

FIG. 5 which is a method for conducting a search for an updated URL;

FIG. 6 which is a method for displaying an updated document;

FIG. 7 which is a method for tracking updates to documents;

FIG. 8 which is a method for determine the best fit of a highlight to an updated document; and

FIG. 9 which is a method for conducting a search of the highlighted documents stored in the data structure.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description of one possible embodiment only and are not intended as a definition of the limits of the invention.

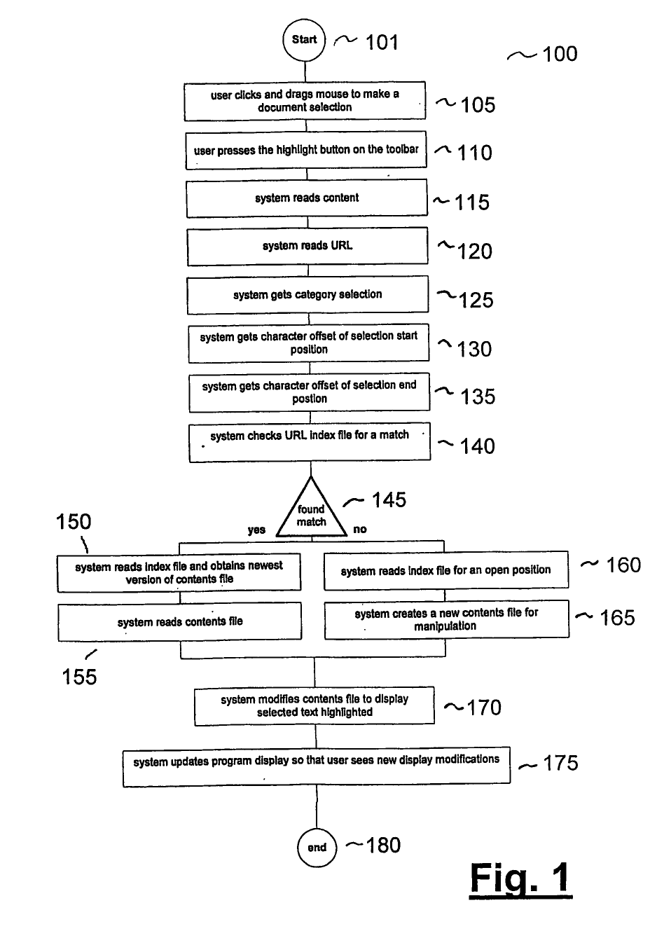

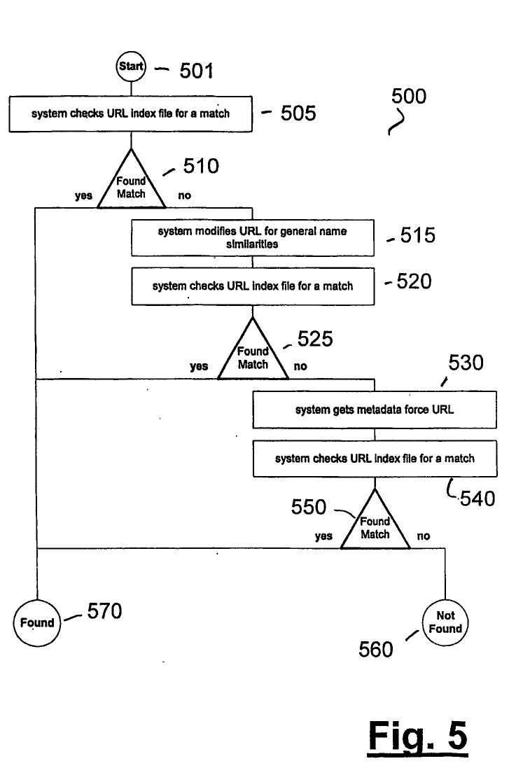

Referring to FIG. 1, a flow chart 100 is shown which describes a system for adding a highlight to a selected document. At the start 101, it is assumed that a user has displayed a document, regardless of source, which the user wishes to add as relevant content to selected data structure. The user is also assumed to be using. a traditional personal computer and is assumed to have a tool bar activated on their screen for operation of the system of the present invention. The user selects the relevant content 105, and highlights it 110 using the tool bar. As a result of highlighting, the system stores 115 the content of the document and the highlighted text. For a document located on the Internet, the system reads the document URL 120, and records the category for storage selection 125. The system then locates the highlighted information by determining the character offset of the start of the selected text 130, and the character offset of the end of the selected text 135. The system then checks to determine whether the URL has been previously saved 140 (See FIG. 5). If a URL match is found 145, the system reads the URL index file and obtains the newest version of the contents file 150, and reads the content file 155. If no URL match is found at step 145, the systems reads an index file for an open position 160, and creates a new contents file 165.

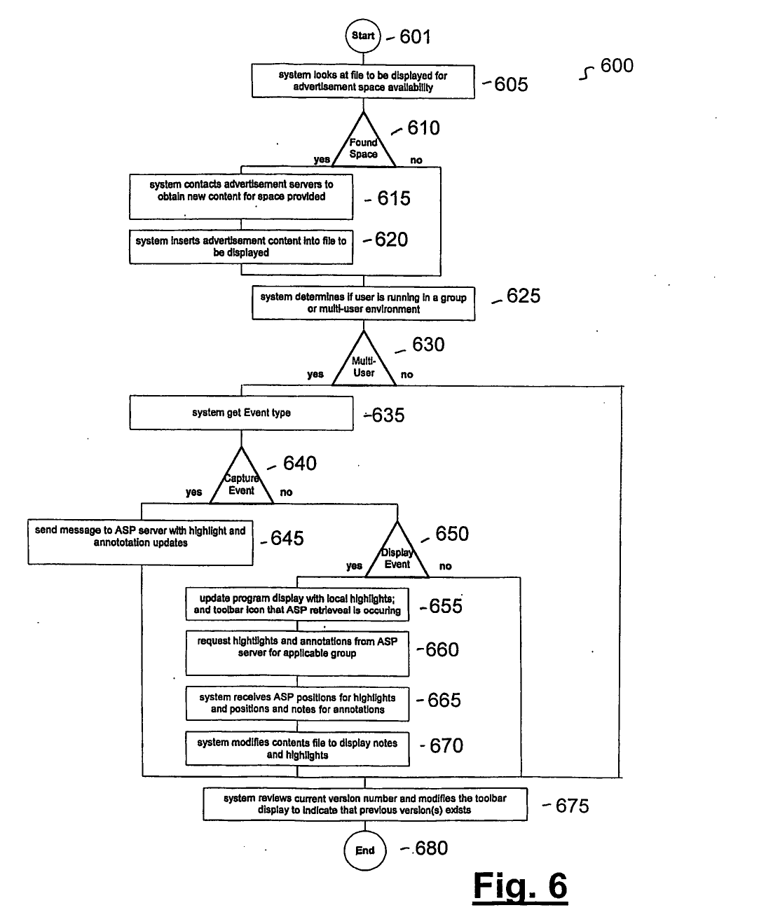

The system then modifies the contents file to display the selected text as being highlighted 170, and then the system updates the display so that the user sees the display modifications 175 (See FIG. 6).

The system has then completed the addition of a highlight to the text of the document, and this stage ends 180.

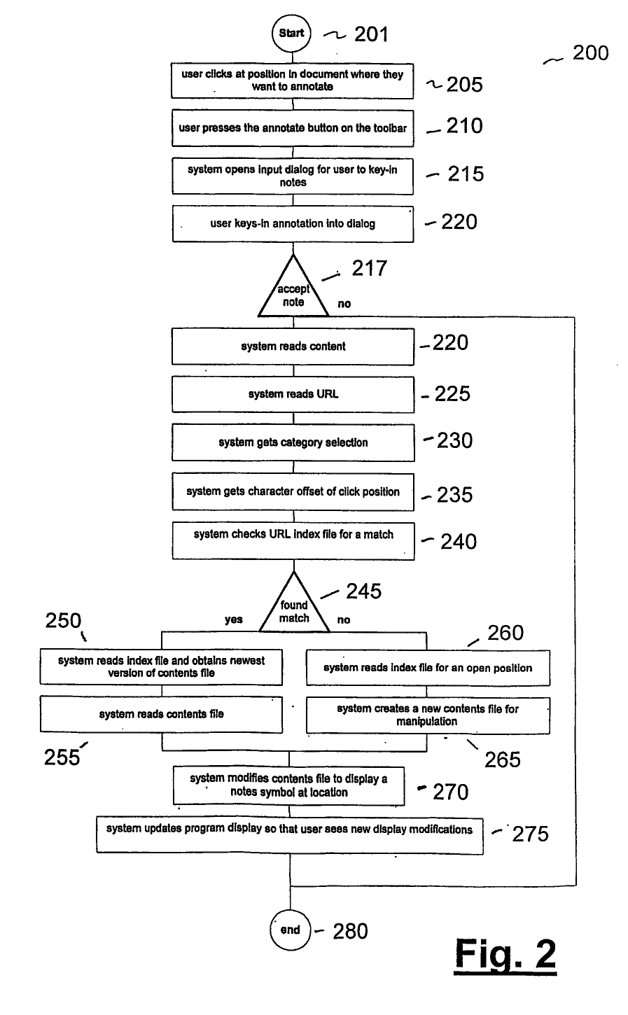

In FIG. 2, a flow chart 200 is shown wherein it is assumed that the user wishes to add a note to a relevant document. The user starts 201 by “clicking” 205 in the document at a location where they wish to add a note. The user then presses the “annotate” button on the system toolbar 210. The system then opens an input dialog box 215 into which the user can type comments or other notes 216. The user is then requested to confirm that the note is to be saved 217. If the answer is “no”, the system ends the process 280. However, it the note is to be saved, the system reads and stores 220 the content of the document and the highlighted text. For a document located on the Internet, the system then reads the document URL 225, and records the category for storage selection 230. The system then locates the position of the note to be added by determining the character offset of the click position 235. The system then checks to determine whether the URL has been previously saved 240 (See FIG. 5). If a URL match is found 245, the system reads the URL index file and obtains the newest version of the contents file 250, and reads the content file 255. If no URL match is found at step 245, the systems reads an index file for an open position 260, and creates a new contents file 265.

The system then modifies the contents file to display a note symbol 270, and then the system updates the display so that the user sees the display modifications 275 (See FIG. 6).

The system has then completed the addition of a note to the text of the document, and this stage ends 280.

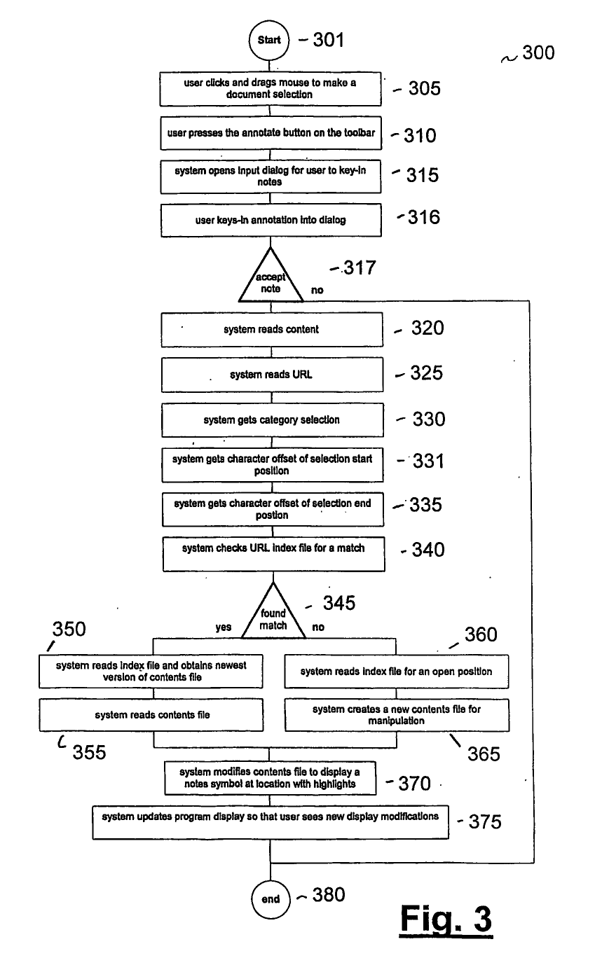

In FIG. 3, a flow chart 300 is shown wherein a paraphrase section is added to the document. The user starts 301 by “clicking and dragging the mouse to make a document selection 305 at a location where they wish to paraphrase a document. The user then presses the “annotate” button on the system toolbar 310. The system then opens an input dialog box 315 into which the user can type comments or other notes 316. The user is then requested to confirm that the paraphrase is to be saved 317. If the answer is “no”, the system ends the process 380. However, it the note is to be saved, the system reads and stores 320 the content of the document and the highlighted text. For a document located on the Internet, the system then reads the document URL 325, and records the category for storage selection 330. The system then locates the position of the note to be added by determining the character offset of the selection start position 331, and the selection end position 335. The system then checks to determine whether the URL has been previously saved 340 (See FIG. 5). If a URL match is found 345, the system reads the URL index file and obtains the newest version of the contents file 350, and reads the content file 355. If no URL match is found at step 345, the systems reads an index file for an open position 360, and creates a new contents file 365.

The system then modifies the contents file to display a paraphrase note symbol 370, and then the system updates the display so that the user sees the display modifications 375 (See FIG. 6).

The system has then completed the addition of a paraphrase note to the text of the document, and this stage ends 380.

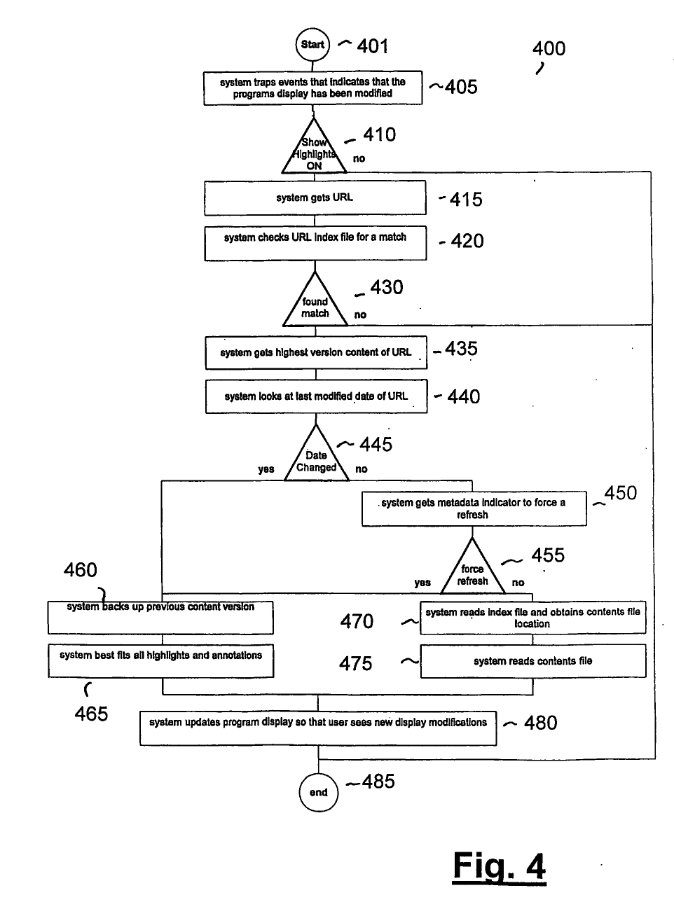

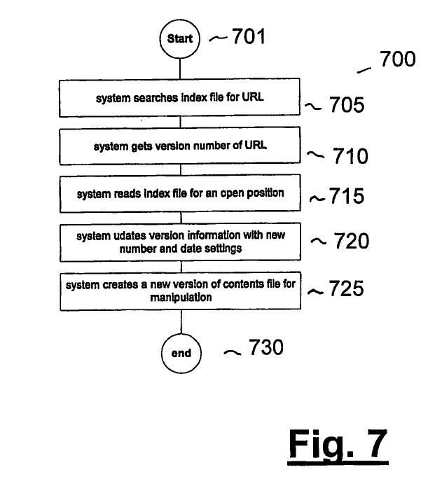

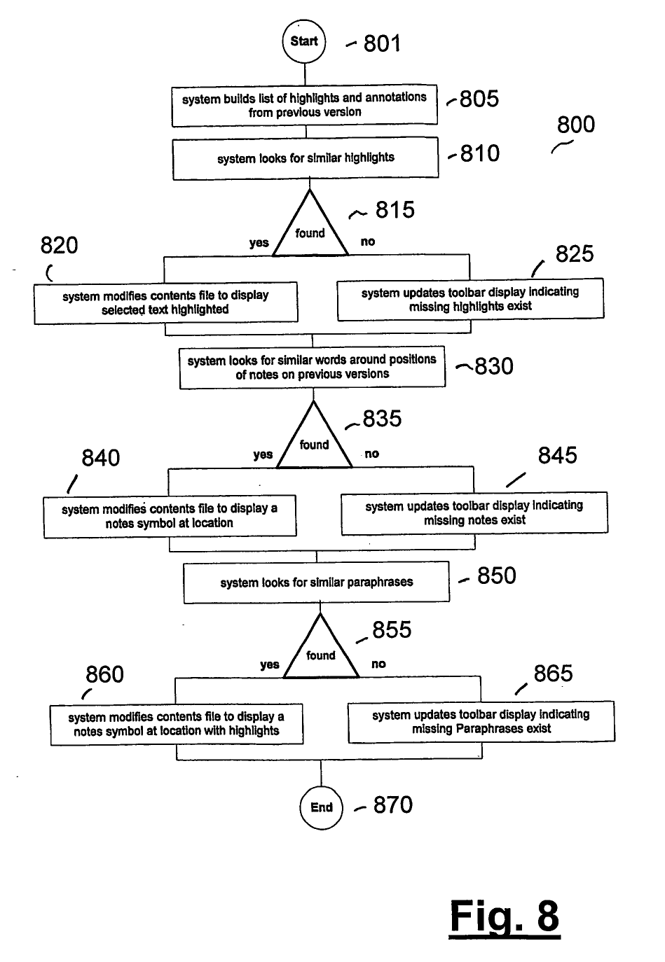

In FIG. 4 a flow chart 400 is shown to describe the process for displaying a modified document. The system starts 401 by trapping an event that indicates that the programs display has been modified 405, and then determines 410 whether the user has requested that the highlights, or the like, are to be displayed. If they are not to be displayed, this portion of the system ends 485. If they are to be displayed, the system retrieves the URL information 415, and checks the URL index file for a match 420 (See FIG. 5). If no match is found 430, the system process ends 485. If a match is found 430, the system retrieves the highest version content of the URL 435 and the system looks at the last modified date of the URL 440. If the URL has not been changed 445, the system gets a metadata indicator, if any, to determine whether to force a refresh of the URL information 450. If the URL information is to be refreshed 455, the system backs up the previous content version 460 (See FIG. 7), and the system best-fits all highlights and annotations to the new file 465 (See FIG. 8).

If no metadata indicator is present, or if the system does not otherwise force a refresh 455, the system reads the index file and obtains the contents file location 470. The system then reads the contents file 475. Once provided with the system content file 475, or the best-fit of the highlights and annotations 465, the system updates the program display so that the user sees the new display modifications 480 (See FIG. 6). This portion of the system then ends 485.

In FIG. 5, a flow chart 500 is shown which describes the URL search and update process for the processes hereinabove described, with respect to an Internet-based document. A similar process would exist for a non-Internet based file.

The system starts 501 by checking the URL index file for a match 505 to a requested document with relevant content. If a match is found 510, the system returns notification 570 that a matching URL has been found. If no match has been found 510, the system modifies the URL for general name similarities 515 and again checks for URL matches to the modified URL name 520. If a match is found 525 to the modified URL, notification 570 is sent that a matching URL has been found. If a match to the modified URL is not found 525, the system gets metadata to force a URL 530. The system then checks the URL index file for a match 540. If a match is found 550, the system returns notification 570 that a matching URL has been found. If no match has been found 550, the system returns notification 560 that no matching URL was found.

In FIG. 6, a flow 600 chart is shown which describes the process for. updating and amending a document to be displayed. The system starts 601 by reviewing a file 605 to determine whether advertising space is available. If space is found 610, the system contacts 615 a source, such as an Application Service Provider (ASP) to obtain new content for a space provided on the page to be displayed. The system then inserts 620 the new content into the space provided. After the advertisement has been inserted, or if space is not found 610, the system determines whether the user is operating in a group or multi-user environment 625. If a multi-user environment is present 630, the system gets an Event type 635.

The system then reviews whether to capture the Event 640. If it does, it sends a message 645 to the server with the highlight and annotation updates. If it does not, it decides 650 whether to display the event. If the event is to be displayed, the system updates 655 the program display with local highlights and notifies the user that information retrieval is occurring. The system then requests 660 highlights and annotations from the ASP. After receipt 665 of the information from the ASP, the system modifies 670 the contents file to display the notes and highlights.

Subsequently, or if a multi-user environment is not present 630, or if there is no captured event 650, the system reviews 675 the current version number and modifies the toolbar display to indicate that previous versions exits 675. This portion of the program then ends 680.

In FIG. 7, a flow chart 700 is shown which describes a process for displaying an updated document. The system starts 701 by searching 705 an index file for a URL. The system then retrieves 710 the version number of the URL. Subsequently, the system reads 715 the index file for an open position, and updates 720 the version information with the new number and date settings. The system then creates 725 a new version of the contents file for manipulation by the system. This part of the process then ends 730.

In FIG. 8, a flow chart 800 is shown which describes a process for determining the best-fit of highlights and notes to a modified display. The system starts 801 by building 805 a list of highlights, notes and annotations from a previous version of the document. The system then reviews 810 the earlier document for similar highlights. If similar highlights are found 815, the system modifies 820 the contents file to display the selected text in a highlighted format. If similar highlights are not found 815, the system updates 825 the toolbar display to indicate missing highlights exist. The system then searches 830 for similar words and positions of notes on previous document versions. If similar words are found 835, the system modifies 840 the file contents to display a notes symbol at that location. If no similar words are found 835, the system updates 845 the toolbar display to indicate missing highlights exist.

The system then searches 850 for similar paraphrases on previous document versions. If similar paraphrases are found 855, the system modifies 860 the file contents to display a notes (or annotation) symbol at that location. If no similar words are found 855, the system updates 865 the toolbar display to indicate missing paraphrases exist.

This portion of the system then ends 870.

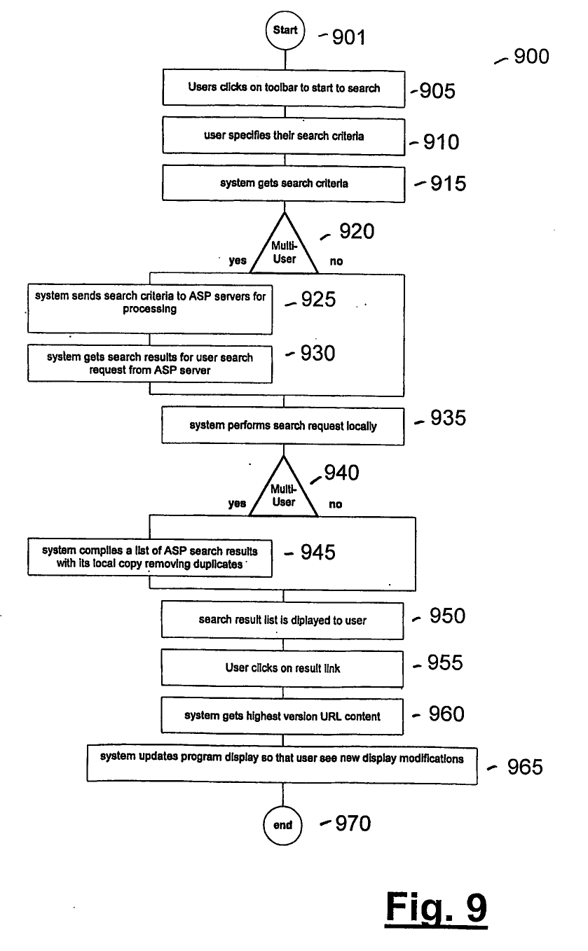

In FIG. 9, a flow chart 900 is shown which provides a system for searching the highlighted content and the notes. The system starts 901 by having the user click 905 on the toolbar to start the search. The user then specifies their search criteria 910, and the system receives the search criteria 915. The system then determines 920 whether a multi-user environment is present. If a multi-user environment is present, the system sends 925 the search criteria to an ASP (for example) for processing, and ultimately, receives 930 the search results. After receiving the ASP search results, or if a multi-user environment is not present, the system performs the search request locally 935.

The system then proceeds by again determining whether a multi-user environment exists 940. If one does, the system compiles 945 a list of ASP search results, compares it with its local results, and removes any duplicates. After this, or if a multi-user environment is not present, the search result list is displayed 950 to the user. The user can then click 955 on the result link from the result list which will prompt the system to retrieve 960 the highest version URL content. The system then updates 965 the program display so that the user sees the new display modifications. This portion of the process then ends 970.

Thus, it is apparent that there has been provided, in accordance with the present invention, an information search and retrieval system, and method, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as comprising and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A computerized method of information retrieval comprising:
providing a computer displayable document having searchable content;
marking said document, with a marking device, as being a relevant document;
storing said relevant document in a user defined data structure; and
conducting a search of a number of said relevant documents using a search engine to identify documents with a desired searchable content;
selecting, using a selection device, the documents identified as having said desired searchable content, and displaying said selected document.

2. A computerized method as claimed in claim 1 wherein a visible document is displayed, and said computerized method is operated by accessing a traditional computer, a PDA, an Internet enabled cellular phones.

3. A computerized method as claimed in claim 1 wherein said document is an Internet web page, a word processor document, a spreadsheet, e-mail or a database file.

4. A computerized method as claimed in claim 1 wherein said document is stored in a fashion so that said searchable content is maintained so that a copy of an original image can be restored, or an updated image can be displayed.

5. A computerized method as claimed in claim 4 wherein said document is stored together with a file location and name, and/or with a URL addresses specific for said document.

6. A computerized method as claimed in claim 1 wherein said document is stored on said user's computer, a local storage device, a remote storage device, a network storage device, an Internet storage device, or an Application Service Provider storage device.

7. A computerized method as claimed in claim 1 wherein said searchable content and/or said relevant content includes text, highlighted text, notes, annotations, summaries, or attachments.

8. A computerized method as claimed in claim 1 wherein said user defined data structure includes a database of stored documents.

9. A computerized method as claimed in claim 8 wherein the relevant content of said database was created by, or is accessible by, said user, and wherein access to said relevant content is controlled by a permission based authorization system.

10. A computerized information retrieval system comprising:
a computer having a display for displaying documents having searchable content;
a marking device for marking document as being a relevant document;
a storage device for storing said relevant document in a user defined database; and
a search engine operatively connected to said computer for conducting a search of a number of said relevant documents in order to identify documents with a desired searchable content;
a selection device for selecting and displaying the documents identified as having said desired searchable content.
